(19) United States
(12) Patent Application Publication
(10) Pub. No.: US 2016/0088180 A1
(43) Pub. Date: Mar. 24, 2016

(54) READING APPARATUS

(71) Applicant: FUJI XEROX CO., LTD., Tokyo (JP)

(72) Inventors: Masaki HACHISUGA, Kanagawa (JP); Kazuya FUKUNAGA, Kanagawa (JP); Takashi HIRAMATSU, Kanagawa (JP); Kiyofumi AIKAWA, Kanagawa (JP); Hideki MORIYA, Kanagawa (JP); Michio KIKUCHI, Kanagawa (JP)

(73) Assignee: FUJI XEROX CO., LTD., Tokyo (JP)

(21) Appl. No.: 14/630,005

(22) Filed: Feb. 24, 2015

(30) Foreign Application Priority Data
Sep. 22, 2014 (JP) 2014-192432

(51) Int. Cl. H04N 1/12; H04N 1/00

(52) U.S. Cl. CPC H04N 1/121; H04N 1/00997

(57) ABSTRACT

Provided is a reading apparatus, including a guiding portion that forms a transporting path and guides a sheet in a transporting direction, and has an opening portion communicated with an outside space of the transporting path, a light-emitting portion that emits the light toward the opening portion from the outside space, a reading portion that reads reflected light, the reflected light being emitted by the light-emitting portion, passing through the opening portion, and being at a reading part of the sheet at a reading position of the transporting path, and a shielding portion that is disposed on the light-emitting portion side of the guiding portion, and shields light which directly reaches the guiding portion among the light emitted from the light-emitting portion.

### CROSS-REFERENCE TO RELATED APPLICATIONS

This application is based on and claims priority under 35 USC 119 from Japanese Patent Application No. 2014-192432 filed Sep. 22, 2014.

### BACKGROUND

### Technical Field

The present invention relates to a reading apparatus.

### SUMMARY

According to an aspect of the invention, there is provided a reading apparatus, including:

a guiding portion that forms a transporting path and guides a sheet in a transporting direction, and has an opening portion communicated with an outside space of the transporting path;

a light-emitting portion that emits the light toward the opening portion from the outside space;

a reading portion that reads reflected light, the reflected light being emitted by the light-emitting portion, passing through the opening portion, and being at a reading part of the sheet at a reading position of the transporting path; and

a shielding portion that is disposed on the light-emitting portion side of the guiding portion, and shields light which directly reaches the guiding portion among the light emitted from the light-emitting portion.

### BRIEF DESCRIPTION OF THE DRAWINGS

Exemplary embodiments of the present invention will be described in detail based on the following figures, wherein:

FIG. 1 is a view illustrating an example of the entire configuration of an image inspection system according to a first exemplary embodiment;

FIG. 2 is a view illustrating an example of a hardware configuration of a reading apparatus;

FIG. 3 is an enlarged view illustrating a scanner portion;

FIG. 4 is a view illustrating a shielding portion when viewed from a light-emitting portion side;

FIG. 5 is a view illustrating an example of an optical path of light emitted by the light-emitting portion;

FIG. 6 is an enlarged view of the shielding portion and a reading part;

FIGS. 7A and 7B are views illustrating an example of the optical path when a position of a sheet is changed;

FIGS. 8A and 8B are views illustrating an example of the optical path when the shielding portion is not provided;

FIGS. 9A and 9B are views illustrating a region in which the light does not directly reach the reading part;

FIG. 10 is an enlarged view of a guiding portion in the vicinity of an opening;

FIGS. 11A and 11B are views comparing a case where an angle θ3 is an acute angle and a case where the angle θ3 is 90 degrees or larger;

FIG. 12 is a view illustrating the shielding portion according to a second exemplary embodiment;

FIG. 13 is a view illustrating an example of the optical path of the light emitted by the light-emitting portion; and

FIG. 14 is a view illustrating the region in which the light does not directly reach the reading part.

### DETAILED DESCRIPTION

### [1] First Exemplary Embodiment

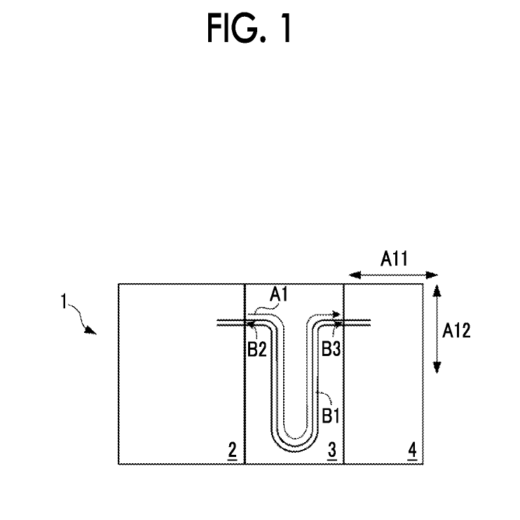

FIG. 1 is a view illustrating an example of the entire configuration of an image inspection system. 1 according to the first exemplary embodiment. The image inspection system 1 is provided with an image forming apparatus 2, a reading apparatus 3, and a post-processing apparatus 4. These apparatuses are connected to each other by wiring which is not illustrated, and data is exchanged between each apparatus via the wiring.

The image forming apparatus 2 forms an image, for example, by an electrophotographic process, on a sheet, such as a paper sheet, a cardboard, or an overhead projector (OHP) film. In addition, a forming method of the image is not limited thereto, and may be an ink jet method or a thermal transfer method. The image forming apparatus 2 forms the image on both surfaces of the sheet, and transports out the sheet on which the image is formed toward the reading apparatus 3 in a horizontal direction A11. In addition, the image forming apparatus 2 sends image data which is used in forming the image to the post-processing apparatus 4.

The reading apparatus 3 transports the sheet transported out of the image forming apparatus 2, up to the post-processing apparatus 4 along a transporting path B1, in a transporting direction A1. After extending toward the post-processing apparatus 4 side from an entrance port B12 on the image forming apparatus 2 side in the horizontal direction A11, the transporting path B1 is formed to be bent facing downward in a vertical direction A12, and to draw a “U” shape from there. After this, the transporting path B1 is bent in the horizontal direction A11, and extends up to a transporting-out port B13 on the post-processing apparatus 4 side. The reading apparatus 3 reads the image formed on the surface of the sheet while transporting the sheet. If the reading apparatus 3 reads the image, the reading apparatus 3 sends result data to the post-processing apparatus 4.

The post-processing apparatus 4 performs processing (hereinafter, refer to as “post-processing”) which is decided with respect to the sheet transported out of the reading apparatus 3. In the exemplary embodiment, the post-processing apparatus 4 performs processing of sorting out the sheet on which the image is accurately formed and the sheet on which the image is not accurately formed, as the post-processing. For example, the post-processing apparatus 4 calculates a matching degree of the image which is illustrated by the image data sent from the image forming apparatus 2 and the image which is illustrated by the result data sent from the reading apparatus 3, and determines that the image is accurately formed on the sheet if the calculated degree exceeds a threshold value. In addition, the post-processing apparatus 4 may perform this determination by using other known technologies.

The image inspection system 1 inspects the image formed on the sheet by operations of each of the above-described apparatuses.

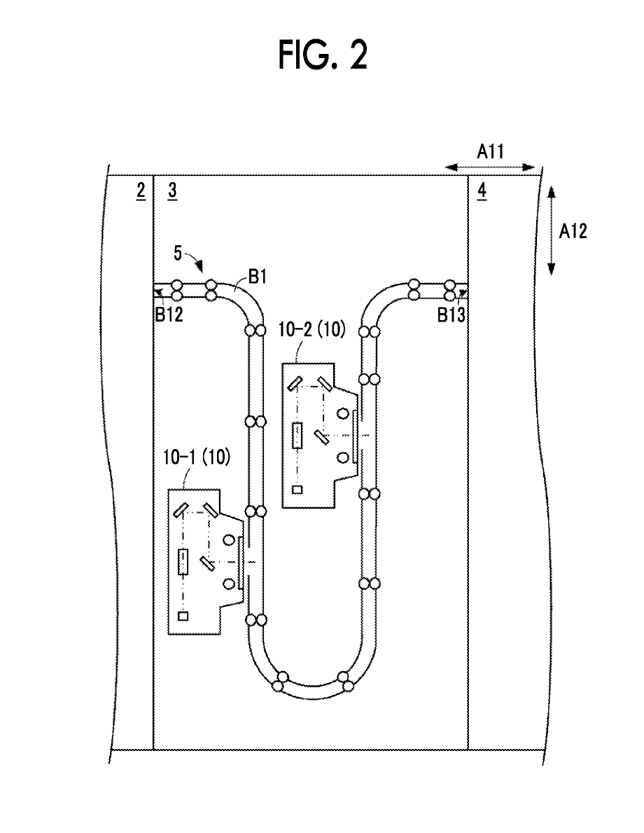

FIG. 2 is a view illustrating an example of a hardware configuration of the reading apparatus 3. The reading apparatus 3 is provided with a transporting portion 5 and scanner portions 10-1 and 10-2 (when the scanner portions 10-1 and 10-2 are not distinguished, called a “scanner portion 10”). The transporting portion 5 includes plural roller pairs which are supported to be rotatable around an axis. The transporting portion 5 gives a driving force to the sheet which is nipped in a nip region formed by the roller pairs by rotating each roller. The sheet which is given the driving force moves along the transporting path B1. The transporting portion 5 transports the sheet along the transporting path B1 in this manner.

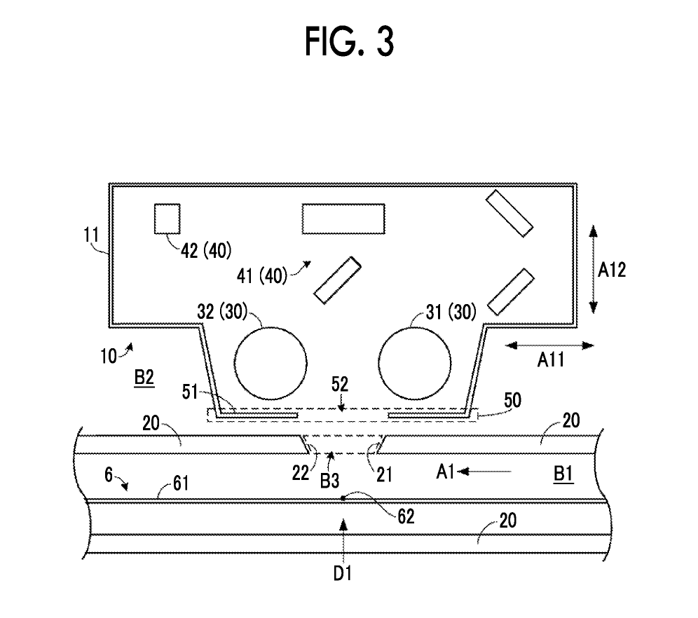

The scanner portion 10 reads the image which is formed on a surface of the sheet transported via the transporting path B1. The scanner portion 10-1 is provided on an upstream side in the transporting direction A1, and the scanner portion 10-2 is provided on the downstream side in the transporting direction A1. In addition, hereinafter, the simple expressions “upstream side” and “downstream side” mean an “upstream side in the transporting direction A1” and a “downstream side in the transporting direction A1”. The scanner portion 10-2 reads the image on a surface opposite to the surface read by the scanner portion 10-1. The scanner portion 10 will be described in detail with reference to FIGS. 3 to 9B. In addition, in these drawings, in order to make the drawings easy to understand, each portion is illustrated by rotating FIGS. 1 and 2 by 90 degrees.

FIG. 3 is an enlarged view illustrating the scanner portion 10. In FIG. 3, a sheet 6 is illustrated as an example of the transported sheet. The scanner portion 10 is provided to be close to the transporting path B1. The transporting path B1 is formed by a guiding portion 20. The guiding portion 20 forms the transporting path B1 and guides the sheet in the transporting direction A1. In the guiding portion 20, an opening B3 which is communicated with an outside space B2 of the transporting path B1 above one surface 61 side of the sheet 6 is provided.

The scanner portion 10 is provided at a position facing the opening B3, in the outside space B2. The scanner portion 10 is provided with a case 11, a light-emitting portion 30, a reading portion 40, and a shielding portion 50. The case 11 accommodates the light-emitting portion 30 and the reading portion 40. An opening B3 side of the case 11 is connected to the shielding portion 50. In addition, the case 11 may include the shielding portion 50 on the opening B3 side. The light-emitting portion 30 emits light toward the opening B3 from the outside space B2. The light-emitting portion 30 includes a first light source 31 and a second light source 32. Both the first light source 31 and the second light source 32 are tools for generating the light, and are, for example, xenon fluorescent lamps or light emitting diodes (LED). The first light source 31 and the second light source 32 are fixed to the case 11. The first light source 31 is provided on an upstream side of the second light source 32 in the transporting direction A1.

The reading portion 40 includes an optical system 41, such as a mirror, and an image sensor 42, such as a CCD sensor or a CMOS sensor. The light which is emitted by the light-emitting portion 30 and passes through the opening B3 is diffuse-reflected by the sheet which reaches a reading position D1 of the transporting path B1. The diffuse-reflected light is guided up to the image sensor 42 by the optical system 41. The image sensor 42 generates an R signal, a G signal, and a B signal which illustrate light quantity values that correspond to three colors, for example, red (R), green (G), and blue (B), from the received reflected light.

In this manner, the reading portion 40 reads the light which is emitted by the light-emitting portion 30, passes through the opening B3, and is reflected at apart (hereinafter, referred to as a “reading part”) 62 which exists at the reading position D1 on the sheet 6 that reaches the reading position D1, that is, the reflected light, and outputs information (RGB signals in the exemplary embodiment) illustrating the read reflected light. The reading position D1 is a position at which the reflected light read by the reading portion 40 is reflected by the sheet, that is, a position at which the reflected light is read. As a control portion which is not illustrated performs processing with respect to the information output in this manner, the image formed on the sheet is read. The control portion sends the data illustrating the read image to the post-processing apparatus 4 as the above-described result data.

The shielding portion 50 is disposed on the light-emitting portion 30 side rather than on the guiding portion 20, and shields a part of the light emitted from the light-emitting portion 30. The shielding portion 50 is connected to the case 11 as described above. In the case 11, the light sources (the first light source 31 and the second light source 32) included in the light-emitting portion 30 are fixed. In other words, a relative position of the shielding portion 50 with respect to the first light source 31 and the second light source 32 is fixed. The shielding portion 50 includes a flat board-shaped member 51, and a slit 52 is formed on the board-shaped member 51.

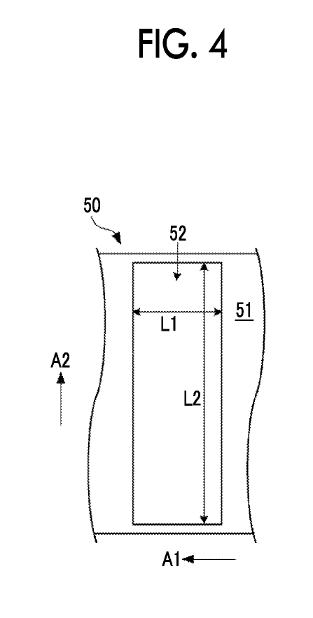

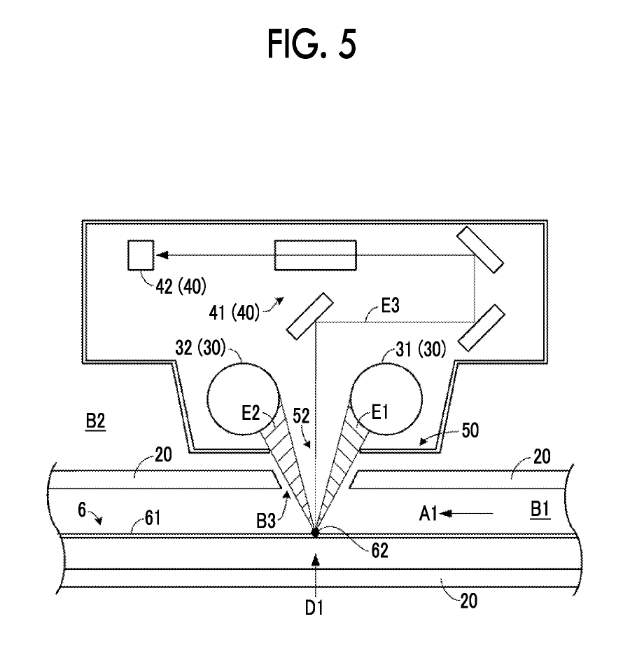

FIG. 4 is a view illustrating the shielding portion 50 when viewed from the light-emitting portion 30 side. In the board-shaped member 51, each slit is formed in a rectangular shape which has a short side along the transporting direction A1, and a long side along a direction which generally makes a 90-degree angle with respect to the transporting direction A1, that is, a main scanning direction A2. A length of the short side of the slit 52 is L1, and a length of the long side is L2. A state where the shielding portion 50 shields the light from the light-emitting portion 30 will be described with reference to FIG. 5.

FIG. 5 is a view illustrating an example of an optical path of the light emitted by the light-emitting portion 30. In FIG. 5, optical paths E1, E2, and E3 illustrating regions through which the light emitted from the light-emitting portion 30 passes, are illustrated. The optical path E1 is a region through which the light which is emitted by the first light source 31 of the light-emitting portion 30 and directly reaches the reading part 62 passes. The optical path E2 is a region, through which the light which is emitted by the second light source 32 and directly reaches the reading part 62, passes. Here, the “light which directly reaches” means the light which directly reaches the reading part 62 without being reflected by something after being emitted from the first light source 31 and the second light source 32. The optical path E3 is a region, through which the reflected light which is reflected by the reading part 62 and is guided up to the image sensor 42 by the optical system 41, passes.

The first light source 31 is disposed on the upstream side of the reading position D1 in the transporting direction A1, and the second light source 32 is disposed on the downstream side of the reading position D1 in the transporting direction A1. For this reason, the optical path E1 is formed on the upstream side of the reading position D1, and the optical path E2 is formed on the downstream side of the reading position D1. The light, which passes through the optical path E1, passes through the slit 52 and the opening B3 in order and reaches the reading part 62. The light, which passes through the optical path E2, passes through the slit 52 and the opening B3 in order and reaches the reading part 62. The light, which passes through the optical path E3, that is, the reflected light reflected by the reading part 62, passes through the opening B3 and the slit 52 in order and reaches the image sensor 42 via the optical system 41.

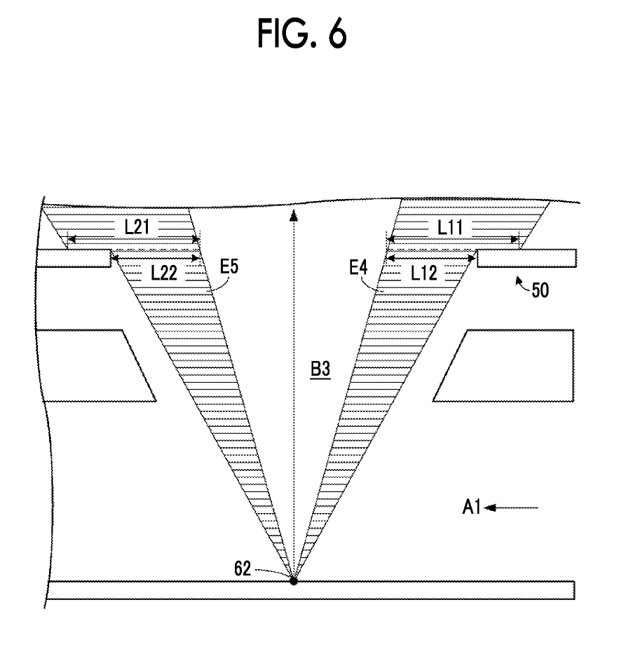

In FIG. 5, the optical paths E1 and E2 do not cross the guiding portion 20. In other words, the light which is emitted from the light-emitting portion 30 does not strike the guiding portion 20. In this manner, the shielding portion 50 shields a part of the light so that the light toward the reading part 62 of the sheet 6 among the light beams emitted from the light-emitting portion 30 does not strike the guiding portion 20. Here, the expression “the light does not strike” means that the light emitted from the light-emitting portion 30 does not directly strike the guiding portion 20, and for example, the expression does not include a case where the diffuse-reflected light by the case 11 or the sheet strikes the guiding portion 20. A state where the shielding portion 50 shields a part of the light will be described in more detail with reference to FIG. 6.

FIG. 6 is an enlarged view of the shielding portion 50 and the reading part 62. In FIG. 6, optical paths E4 and E5 which are regions through which the light which is emitted from the light-emitting portion 30 and faces the reading part 62 passes are illustrated. A part of the light which passes through the optical paths E4 and E5 is shielded in the middle by the shielding portion 50 before reaching the reading part 62. For this reason, for example, a width of the optical path E4 in the transporting direction A1 before being shielded is L11, but a width in the transporting direction A1 after being shielded becomes narrower to be L12 (L12<L11).

In addition, a width of the optical path E5 in the transporting direction A1 before being shielded is L21, but a width in the transporting direction A1 after being shielded becomes narrower to be L22 (L22<L21). In addition, the optical path E4 after the width thereof becomes narrower is a region which is overlapped with the optical path E1 illustrated in FIG. 5, and the optical path E5 after the width thereof becomes narrower is a region which is overlapped with the optical path E2 illustrated in FIG. 5. In this manner, the shielding portion 50 shields a part of the light so that the width of the transporting direction A1 of the region (that is, the optical paths E4 and E5) through which the light facing the reading part 62 among the light beams emitted from the light-emitting portion 30 passes becomes narrower in the middle on the light-emitting portion 30 side than the opening B3. The optical path of the light, a part of which is shielded by the shielding portion 50 in this manner, changes by the position of the sheet as follows.

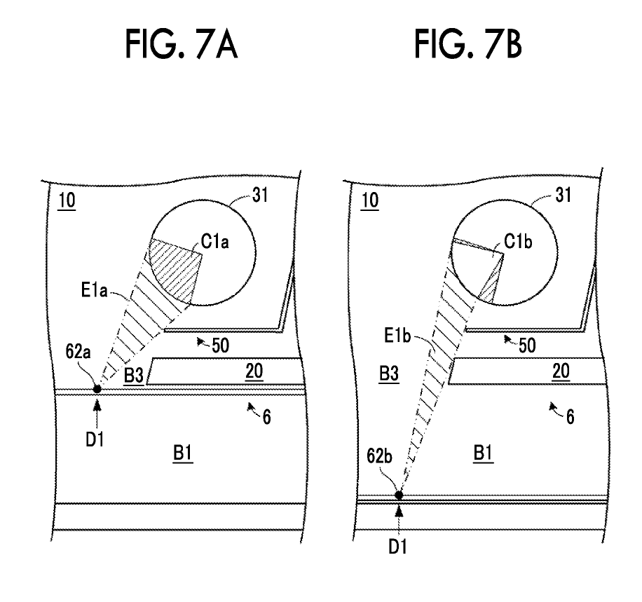

FIGS. 7A and 7B are views illustrating an example of the optical path when the position of the sheet is changed. FIG. 7A is a view of the sheet 6 transported in a state of being the nearest to the opening B3. FIG. 7B is a view of the sheet 6 transported in a state of being the most apart from the opening B3. In FIG. 7A, a reading part 62a of the sheet 6 which exists at the reading position D1 and an optical path E1a of the light which is emitted from the first light source 31 and directly reaches the reading part 62a, are illustrated. In FIG. 7A, a sector C1a which has an arc drawn by a front surface that sheds the light passing through the optical path E1a is illustrated as a shaded region.

In FIG. 7B, a reading part 62b of the sheet 6 which exists at the reading position D1 and an optical path E1b of the light which is emitted from the first light source 31 and directly reaches the reading part 62b, are illustrated. In FIG. 7B, a sector C1b which has an arc drawn by the front surface that sheds the light passing through the optical path E1b is illustrated, and the sector C1a is illustrated as overlapped with the sector C1b. The sector C1b has a size fitting into the sector C1a. This means that an amount of light which directly reaches the reading part 62a becomes large by the amount of the light shed from the front surface of the part protruded from the sector C1b in the sector C1a, compared to an amount of light which directly reaches the reading part 62b.

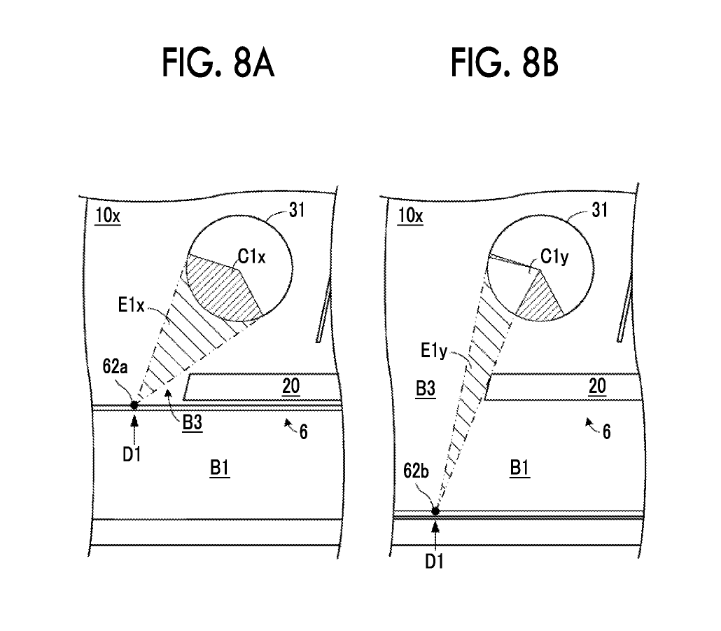

A difference in the amount (hereinafter, simply referred to as a “light amount”) of light which directly reaches the reading part when the shielding portion 50 is not provided, will be described with reference to FIGS. 8A and 8B.

FIGS. 8A and 8B are views illustrating an example of the optical path when the shielding portion 50 is not provided. In FIGS. 8A and 8B, a scanner portion 10x which does not include the shielding portion 50 is illustrated, and other conditions are common with those in FIGS. 7A and 7B. In FIG. 8A, an optical path Fix of the light which is emitted from the first light source 31 and directly reaches the reading part 62a is illustrated. In FIG. 8B, an optical path E1y of the light, which is emitted from the first light source 31 and directly reaches the reading part 62b, is illustrated.

In FIG. 8A, a sector C1x which has an arc drawn by the front surface that sheds the light passing through the optical path E1x is illustrated as a shaded region. In FIG. 8B, a sector C1y which has an arc drawn by the front surface that sheds the light passing through the optical path E1y is illustrated, and the sector C1x is illustrated to be overlapped with the sector C1y. The sector C1y has a size to fitting into the sector C1x. For this reason, even in the example in FIGS. 8A and 8B, similarly to the example in FIGS. 7A and 7B, an amount of light at the reading part 62a becomes larger compared to an amount of light at the reading part 62b.

However, an area of the front surface of the part protruded from the sector C1y in the sector C1x becomes larger than an area of a front surface of the part protruded from the sector C1b in the sector C1a. For this reason, in the example in FIGS. 8A and 8B, a difference in the amount of light at the reading parts 62a and 62b becomes larger compared to the example in FIGS. 7A and 7B. In other words, as the shielding portion 50 is provided similarly to the exemplary embodiment, compared to a case where the shielding portion 50 is not provided, a difference in the amount of light when the distance between the opening B3 and the sheet 6 changes becomes smaller.

Similarly to the reading apparatus 3, in an apparatus which emits the light that passes through the opening with respect to the transported sheet and reads the reflected light, the sheet is likely to jump out to an outer space from the apparatus if the opening is too large. For this reason, it is desirable that the opening be as small as possible. However, even when the guiding portion 20 does not block the light in a case where the sheet is transported to a near side of the opening as illustrated in FIG. 8A as the opening becomes smaller, the guiding portion 20 is likely to shield the light and the amount of shielded light is likely to increase in a case where the sheet is transported to a far side from the opening as illustrated in the example in FIG. 8B. As a result, when the distance between the sheet and the opening changes, a change in an intensity of light which reaches the reading part of the sheet is likely to increase, and further, a change in the intensity of the reflected light at the reading part increases.

As the shielding portion 50 is provided in the exemplary embodiment, the light which faces the reading part of the sheet 6 among the light beams emitted from the light-emitting portion 30 does not strike the guiding portion 20, and thus, the difference in the amount of light when the distance between the opening B3 and the sheet 6 changes as described above, becomes smaller compared to the example in FIGS. 8A and 8B. Therefore, in the exemplary embodiment, when the light which is emitted by passing through the opening B3 and reflected by the sheet 6 is read, compared to a case where the shielding portion 50 is not provided, similarly to the example in FIGS. 8A and 8B, the change in intensity of the reflected light when the distance between the opening B3 and the sheet 6 changes becomes smaller.

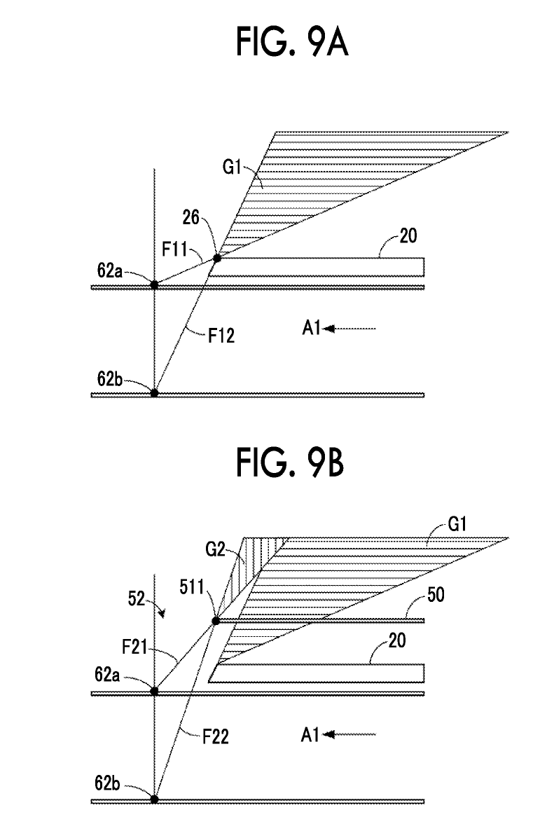

The reason that the change in intensity of the reflected light becomes smaller as the shielding portion 50 is provided will be described in more detail with reference to FIGS. 9A and 9B.

FIGS. 9A and 9B are views illustrating a region in which the light does not directly reach the reading part. In FIG. 9A, a case where the shielding portion 50 is not provided is illustrated, and in FIG. 9B, a case where the shielding portion 50 is provided is illustrated. In FIG. 9A, a space G1 which is nipped by a first virtual surface F11 which is a virtual surface that connects the reading part 62a (when the sheet is transported to the side near to the opening B3) and an end 26 on the downstream side of the guiding portion 20 in the transporting direction A1, and a second virtual surface F12 which is a virtual surface that connects the reading part 62b (when the sheet is transported to a side far from the opening B3) and the end 26, is illustrated. The light shed in the space G1 directly reaches the reading part 62a, but does not directly reach the reading part 62b since shielding is performed by the guiding portion 20.

In FIG. 9B, a space G2 which is nipped by a first virtual surface F21 which is a virtual surface that connects the reading part 62a and an end 511 on the upstream side of the slit 52 in the transporting direction A1, and a second virtual surface F22 which is a virtual surface that connects the reading part 62b and the end 511, is illustrated. The light shed in the space G2 directly reaches the reading part 62a, but does not directly reach the reading part 62b since shielding is performed by the shielding portion 50. For this reason, when a light source exists in the spaces G1 and G2, the light shed from the part where the light source exists in these spaces is the reason for the difference in intensity of light when the distance between the opening B3 and the sheet 6 changes.

In FIG. 9B, the space G1 is illustrated to be overlapped. As illustrated in this drawing, the space G2 becomes smaller compared to the space G1. The reason thereof is that an angle which is made by the first surface and the second surface becomes smaller when the shielding portion 50 is provided compared to a case where the shielding portion 50 is not provided, since the shielding portion 50 is apart from the sheet more than the guiding portion 20. In this manner, as the shielding portion 50 is provided, the space which sheds the light that directly reaches the reading part 62a but does not directly reach the reading part 62b becomes smaller compared to a case where the shielding portion 50 is not provided (that is, the space G2 becomes smaller compared to the space G1), and the amount of light which causes the above-described difference in intensity of light is also likely to become smaller. In particular, when the light source becomes larger, the part existing in the space G1 becomes larger. For this reason, the difference in intensity of light at the reading part when the shielding portion 50 is provided as described above becomes smaller.

In addition, for example, when the scanner portion 10 is to be installed so that the amount of light from the first light source 31 and the second light source 32 are the same as each other, there is a case where the installation position is shifted in the transporting direction A1. In this case, a size in the space G1 illustrated in FIG. 9A changes on the upstream side and the downstream side, and the amount of light at the reading part changes in the first light source 31 and the second light source 32. In addition, the difference in the amount of light when the distance between the opening B3 and the sheet 6 changes, also changes in the first light source 31 and the second light source 32.

In this manner, when the installation position of the light source is shifted in the transporting direction A1 with respect to the opening B3, a balance of the amount of light which reaches the reading part on the upstream side and the downstream side changes. For this reason, for example, when the reflected light from one light source becomes larger compared to the reflected light from the other light source in a state where the front surface of the one surface 61 of the sheet 6 is uneven, the difference in amount of reflected light increases, and the number of reading errors increases. In the exemplary embodiment, since the relative position of the shielding portion 50 with respect to both light sources is fixed, compared to a case where the relative position of the shielding portion 50 is not fixed, the number of the above-described reading errors decreases.

Next, a shape of the guiding portion 20 in the vicinity of the opening B3 will be described in detail.

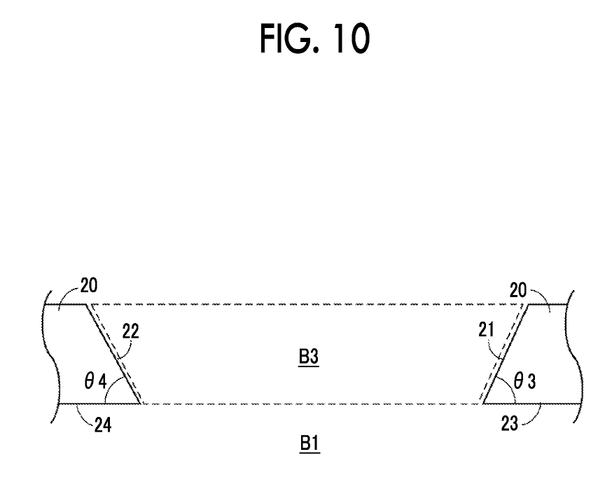

FIG. 10 is an enlarged view of the guiding portion 20 in the vicinity of the opening B3. The guiding portion 20 includes a first surface 21 which forms the opening B3 on the upstream side of the opening B3, and a second surface 22 which forms the opening B3 on the downstream side of the opening B3. In addition, the guiding portion 20 includes a first inner surface 23 which continues to the first surface 21 and faces the transporting path B1, and a second inner surface 24 which continues to the second surface 22 and faces the transporting path B1. The first surface 21 and the first inner surface 23 make an angle θ3, and the second surface 22 and the second inner surface 24 make an angle θ4. Both the angle θ3 and the angle θ4 are less than 90 degrees, that is, are acute angles.

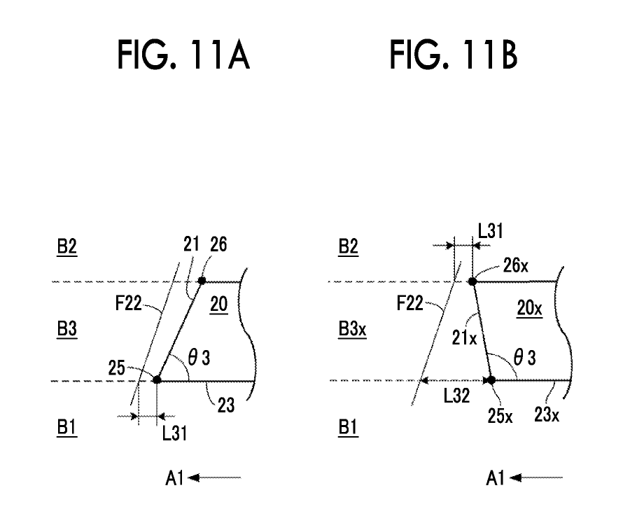

As the angles θ3 and θ4 are the acute angles, compared to a case where these angles are 90 degrees or larger, the sheet is unlikely to jump out to the outside space B2 from the opening B3. The reason thereof will be described with reference to FIGS. 11A and 11B.

FIGS. 11A and 11B are views comparing a case where the angle θ3 is the acute angle and a case where the angle θ3 is 90 degrees or larger. In FIG. 11A, the guiding portion 20 in the exemplary embodiment and the second virtual surface F22 (a virtual surface which connects the reading part 62b and the end 511 of the slit 52) illustrated in FIGS. 9A and 9B are illustrated to be enlarged.

When the guiding portion 20 and the second virtual surface F22 cross each other, a part of the light which passes through the slit of the shielding portion 50 is shielded by the guiding portion 20, and the amount of light which reaches the reading part 62b decreases. For this reason, it is desirable that the guiding portion 20 not cross the second virtual surface F22. In the exemplary embodiment, in consideration of tolerance during manufacturing, the guiding portion 20 is disposed to be apart from the second virtual surface F22 only by a distance L31. In addition, the distance illustrated in FIGS. 11A and 11B is a distance along the transporting direction A1. In this example, an angle 25 which is made by first surface 21 and the first inner surface 23 is closer to the second virtual surface F22 than an angle 26 formed on the outside space B2 side of the first surface 21, and a distance between the angle 25 and the second virtual surface F22 is the distance L31.

In FIG. 11B, a guiding portion 20x in which the above-described angle θ3 is 90 degrees or larger is illustrated. The guiding portion 20x includes a first surface 21x, a first inner surface 23x, an angle 25x, and an angle 26x. Similarly to the guiding portion 20, the guiding portion 20x is also disposed to be apart from the second virtual surface F22 only by the distance L31. In this case, a distance between the angle 26x and the second virtual surface F22 is the distance L31, and a distance between the angle 25x and the second virtual surface F22 is a distance L32 which is larger than distance L31. An opening B3x is provided in the guiding portion 20x.

In the opening B3 in the exemplary embodiment, the transporting path B1 side is narrower as the angle 25 of the guiding portion 20 is closer to the second virtual surface F22 than the angle 25x of the guiding portion 20x illustrated in FIG. 11B, compared to the opening B3x, and a tip end of the transported sheet is unlikely to get into the opening B3. In this manner, in the exemplary embodiment, compared to a case where the first surface 21 and the first inner surface 23 make an angle which is 90 degrees or larger, the sheet is unlikely to jump out to the outside space B2 from the opening B3. This is also applied to the downstream side of the opening B3. In other words, in the exemplary embodiment, compared to a case where the second surface 22 and the second inner surface 24 make an angle which is 90 degrees or larger, the sheet is unlikely to jump out to the outside space B2 from the opening B3.

### [2] Second Exemplary Embodiment

Hereinafter, the second exemplary embodiment of the invention will be described focusing on a difference between the first exemplary embodiment and the second exemplary embodiment. In the first exemplary embodiment, the light which passes through the upstream side in the transporting direction A1 is shielded in the optical path of the light emitted from the first light source 31, and the light which passes through the downstream side in the transporting direction A1 is shielded in the optical path of the light emitted from the second light source 32. However, in the second exemplary embodiment, the lights at both sides of the first light source 31 and the second light source 32 are respectively shielded.

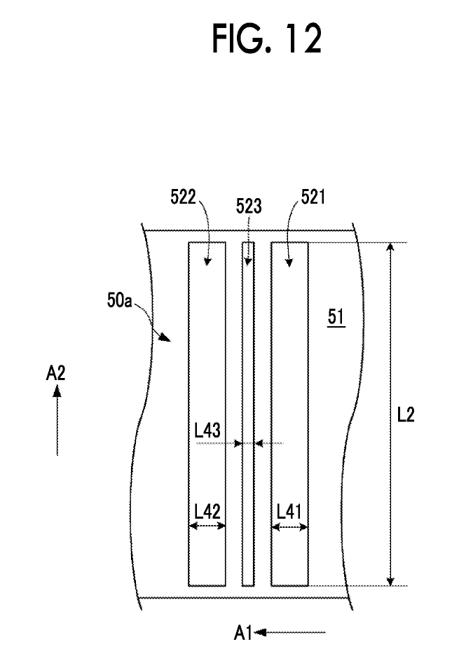

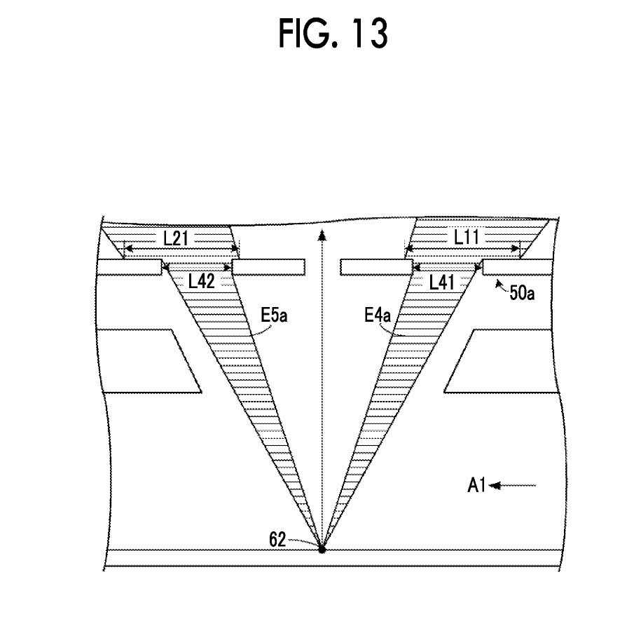

FIG. 12 is a view illustrating a shielding portion 50a according to the second exemplary embodiment. In the board-shaped member 51 of the shielding portion 50a, slits 521, 522, and 523 are formed. These slits are respectively formed in a rectangular shape which has a short side along the transporting direction A1 and a long side having a length of L2 along the main scanning direction A2, similarly to the slit 52 illustrated in FIG. 4. The lengths of the short sides of the slits 521, 522, and 523 are respectively L41, L42, and L43. In the exemplary embodiment, L41=L42>L43. Each slit is aligned in order of 521, 523, and 522 from the upstream side in the transporting direction A1. A state where the shielding portion 50a shields the light from the light-emitting portion 30 will be described with reference to FIG. 13.

FIG. 13 is a view illustrating an example of the optical path of the light emitted by the light-emitting portion 30. In FIG. 13, optical paths E4a and E5a, which are regions through which the light facing the reading part 62 passes, are illustrated. A part of the light which passes through the optical paths E4a and E5a is shielded by the shielding portion 50 in the middle before reaching the reading part 62. A width of the optical path E4a in the transporting direction A1 before being shielded is L11, similarly to FIG. 6, but a width in the transporting direction A1 after being shielded becomes narrower to be L41 which is the width of the slit 521 (L41<L11). In addition, a width of the optical path E5a in the transporting direction A1 before being shielded is L21, similarly to FIG. 6, but a width in the transporting direction A1 after being shielded becomes narrower to be L42 (L42<L21) which is the width of the slit 522. In this manner, the widths of the optical paths E4a and E5a in the transporting direction A1 become narrower in the middle on the light-emitting portion 30 side than the opening B3, similarly to the optical paths E4 and E5 illustrated in FIG. 6.

In addition, the optical path E4 illustrated in FIG. 6 in the first exemplary embodiment is an optical path in which the upstream side in the transporting direction A1 becomes narrower in the middle, but the optical path E4a illustrated in FIG. 13 is an optical path in which both the upstream side and the downstream side in the transporting direction A1 become narrower in the middle. The optical path E5a is also an optical path in which both the upstream side and the downstream side in the transporting direction A1 become narrower in the middle. In other words, the shielding portion 50a shields a part of the light facing the reading part 62 so that both the upstream side and the downstream side of the optical path E4a become narrower in the middle, and both the upstream side and the downstream side of the optical path E5a become narrower in the middle.

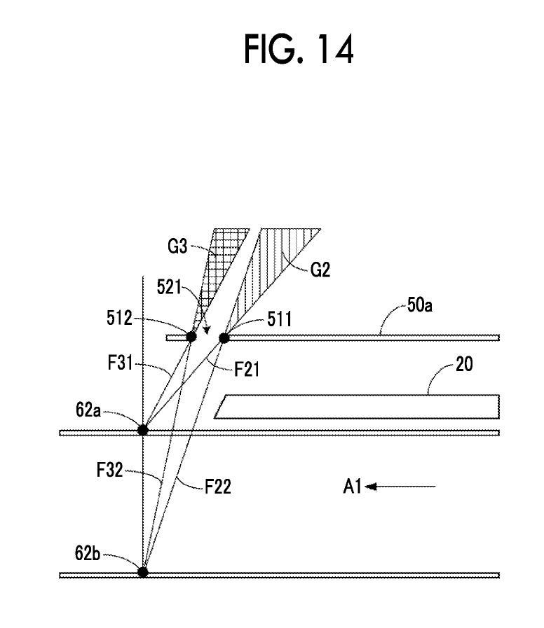

The amount of light at the reading part when the light is shielded by the shielding portion 50a will be described with reference to FIG. 14.

FIG. 14 is a view illustrating the region in which the light does not directly reach the reading part. In FIG. 14, in addition to the space G2 illustrated in FIG. 9B, a space G3 which is nipped by a first virtual surface F31 which is a virtual surface that connects the reading part 62a and an end 512 on the downstream side of the slit 521 in the transporting direction A1, and a second virtual surface F32 which is a virtual surface that connects the reading part 62b and the end 512, are illustrated. The light shed in the space G3 directly reaches the reading part 62b, but does not directly reach the reading part 62a since shielding is performed by the shielding portion 50.

The light shed from the light source which exists in the space G2 reaches the reading part 62a, but the light shed from the light source which exists in the space G3 does not reach the reading part 62a. Meanwhile, the light shed from the light source which exists in the space G2 does not reach the reading part 62b, but the light shed from the light source which exists in the space G3 reaches the reading part 62b. In the first exemplary embodiment, as described in FIGS. 7A and 7B, the amount of light (hereinafter, referred to as a “first amount of light”) at the reading part 62b is smaller than the amount of light (hereinafter, referred to as a “second amount of light”) at the reading part 62a. However, in the second exemplary embodiment, since the light shed from the light source which exists at the space G3 is reduced from the first amount of light and is added to the second amount of light, the difference thereof becomes smaller. Therefore, according to the exemplary embodiment, compared to a case where the region through which the light facing the reading part 62 passes becomes narrower in the middle on only one of the upstream side and the downstream side, a change in intensity of the reflected light when the distance between the opening and the sheet changes becomes further smaller.

### [3] Modification Example

Each of the above-described exemplary embodiments is merely an example of the invention, and may be modified as follows. In addition, each exemplary embodiment described above and each modification example described below may be combined with each other if necessary.

[3-1] Processing Based on Reading Result

In each exemplary embodiment, processing of reading the image formed on the sheet based on the result of reading the reflected light by the reading portion 40 is performed, but the invention is not limited thereto. For example, processing of determining the presence or the absence of a stain or a scratch on the sheet may be performed, processing of comparing a color of the read reflected light to a reference color (more specifically, for example, processing of determining whether or not the color of the image on the sheet is printed in a right color, or the like) may be performed, processing of comparing the image on the sheet to a reference image (image which is an original image of the image printed on the sheet) may be performed, or processing of determining whether the image on the sheet is a color image or a black and white image may be performed. In this manner, if processing is performed based on the result of reading the reflected light by the reading portion 40, any processing may be performed.

[3-2] Reflected Light

The reading portion 40 reads the diffuse-reflected light in each exemplary embodiment, but the invention is not limited thereto. This is because, for example, if the above-described processing of determining the presence or the absence of a stain or a scratch on the sheet is performed, it is also considered that the reading portion 40 reads totally-reflected light. In short, if the reflected light is the reflected light reflected by the sheet which is transported through the transporting path, any reflected light may be read by the reading portion 40.

[3-3] Number of Slits

The shielding portion includes one slit in the first exemplary embodiment, and three slits in the second exemplary embodiment, but the invention is not limited thereto. For example, the shielding portion may include two slits (for example, the slits 523 and 521 in FIG. 12 may be communicated with each other), or may include four or more slits (for example, the slit 521 in FIG. 12 may be divided in the transporting direction A1 or in the main scanning direction A2 to be two slits).

[3-4] Size of Slit

In the second exemplary embodiment, the shielding portion shields a part of the light facing the reading part 62 so that the optical paths E4a and E5a illustrated in FIG. 13 become narrower in the middle on both the upstream side and the downstream side, but the invention is not limited thereto. For example, if the slit 521 illustrated in FIG. 12 widens on the upstream side, and the slit 522 widens on the downstream side, apart of the light is shielded so that the region through which the light facing the reading part 62 passes becomes narrower in the middle on one of the upstream side or the downstream side.

Specifically, in a case of the light from the first light source 31 provided on the upstream side of the reading part 62, the downstream side of the optical path becomes narrower in the middle, and in a case of the light from the second light source 32 provided on the downstream side of the reading part 62, the upstream side of the optical path becomes narrower in the middle. Even in this case, since the light shed from the light source which exists in the space G3 illustrated in FIG. 14 is reduced from the first amount of light, and the light is added to the second amount of light, the difference between both amounts of light decreases.

[3-5] Distance between Opening and Sheet

In each exemplary embodiment, regardless of the position of the sheet, the shielding portion shields a part of the light so that the light facing the reading part 62 does not strike the guiding portion 20, but the invention is not limited thereto. For example, as illustrated in FIG. 7B, the light facing the reading part 62b of the sheet 6 transported in a state of being the most apart from the opening B3 may strike the guiding portion 20.

Even in this case, as illustrated in FIG. 7A, if the light facing the reading part 62a of the sheet 6 transported in a state of being the nearest to the opening B3 does not strike the guiding portion 20, compared to a case illustrated in FIGS. 8A and 8B, the difference between the above-described first amount of light and the second amount of light decreases. In this manner, according to the first exemplary embodiment, the shielding portion 50 may shield a part of the light so that the light facing the reading part 62a of the sheet 6 transported in a state of being the nearest to the opening B3 among the light beams emitted from the light-emitting portion 30 does not strike the guiding portion 20.

In addition, even in the second exemplary embodiment, the difference between the above-described first amount of light and the second amount of light decreases if the light source exists in the space G3 illustrated in FIG. 14. For this reason, it is necessary that the light facing the reading part 62a be shielded, but it is not necessary that the light facing the reading part 62b be shielded. In other words, the shielding portion 50a may shield a part of the light so that the region through which the light facing the reading part 62a of the sheet 6 transported in a state of being the nearest to the opening B3 among the light beams emitted from the light-emitting portion 30 passes becomes narrower in the middle on both the upstream side and the downstream side in the transporting direction A1.

[3-6] Supporting Method of Shielding Portion

In each exemplary embodiment, the shielding portion is supported by the case 11 while being connected to the case 11, but the invention is not limited thereto. For example, the shielding portion may be supported by the entire case of the reading apparatus 3 or the guiding portion 20 while being connected to the entire case of the reading apparatus 3 or the guiding portion 20. In both cases, the shielding portion may be supported to shield a part of the light emitted from the light-emitting portion 30 as described above, and desirably, the shielding portion may be supported to fix the relative position thereof with respect to the light source.

[3-7] Light Source

The light-emitting portion includes two light sources, such as the first light source 31 and the second light source 32, in each exemplary embodiment, but may include only one of the light sources. In addition, it is not necessary that each light source be a single-body tool, and may be a tool (for example, a tool in which plural LEDs are aligned in the main scanning direction A2) which is a combination of plural tools.

[3-8] Category of Invention

The invention may be considered as an invention regarding an image inspection system which is provided with the reading apparatus, the image forming apparatus, and the post-processing apparatus, other than an invention regarding the reading apparatus. In addition, in the reading apparatus, a function of forming the image or a function of performing post-processing may be provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A reading apparatus, comprising:
a guiding portion that forms a transporting path and guides a sheet in a transporting direction, and has an opening portion communicated with an outside space of the transporting path;
a light-emitting portion that emits the light toward the opening portion from the outside space;
a reading portion that reads reflected light, the reflected light being emitted by the light-emitting portion, passing through the opening portion, and being at a reading part of the sheet at a reading position of the transporting path; and
a shielding portion that is disposed on the light-emitting portion side of the guiding portion, and shields light which directly reaches the guiding portion among the light emitted from the light-emitting portion.

2. The reading apparatus according to claim 1, wherein
in the shielding portion, a region in which the light emitted from the light-emitting portion is shielded is on an upstream side and on a downstream side in the transporting direction.

3. The reading apparatus according to claim 1, wherein
the light-emitting portion includes a first light source that is disposed on an upstream side of the reading position in the transporting direction and a second light source that is disposed on a downstream side of the reading position in the transporting direction, and
a relative position of the shielding portion is fixed with respect to the first light source and the second light source.

4. The reading apparatus according to claim 1, wherein
the guiding portion has a first surface that forms the opening portion on an upstream side of the opening portion in the transporting direction, and a first inner surface that continues to the first surface and faces the transporting path, and
the first surface and the first inner surface form an acute angle.

5. The reading apparatus according to claim 1, wherein
the guiding portion has a second surface that forms the opening portion on a downstream side of the opening portion in the transporting direction, and a second inner surface that continues to the second surface and faces the transporting path, and
the second surface and the second inner surface form an acute angle.

6. The reading apparatus according to claim 1, wherein
the shielding portion has a plurality of slits.

7. The reading apparatus according to claim 1, wherein
the shielding portion has three slits.

8. The reading apparatus according to claim 7, wherein
three slits of the shielding portion, a width of a slit in a center portion is narrower than a width of the other slits.

9. The reading apparatus according to claim 1, wherein
the shielding portion is connected to a case of the reading apparatus.

10. The reading apparatus according to claim 1, wherein
the shielding portion is a flat plate.
